(19) United States
(12) Patent Application Publication
(10) Pub. No.: US 2015/0327037 A1
(43) Pub. Date: Nov. 12, 2015

(54) METHOD AND SYSTEM FOR CREATING A SOCIAL GROUP FOR MOBILE LOCK SCREEN FOR SHARING DIGITAL CONTENT

(71) Applicant: Jian Wei Tam, New York, NY (US)

(72) Inventor: Jian Wei Tam, New York, NY (US)

(21) Appl. No.: 14/294,151

(22) Filed: Jun. 3, 2014

Related U.S. Application Data
(60) Provisional application No. 61/991,449, filed on May 10, 2014.

(51) Int. Cl. H04W 4/20; H04L 29/06; H04M 1/67

(52) U.S. Cl. CPC H04W 4/206; H04M 1/67; H04L 65/40; H04W 4/20

(57) ABSTRACT

A method and system for creating a social group for mobile lock screen for sharing digital content. Particularly, the application provides a method and system for creating a social group for mobile communication device's lock screen for sharing digital content using a mobile lock screen application.

### CROSS-REFERENCE TO RELATED APPLICATION

The present application is related to provisional patent application Ser. No. 61/991,449, filed on May 10, 2014, and titled “A METHOD AND SYSTEM FOR CREATING A SOCIAL GROUP FOR LOCK SCREEN FOR SHARING DIGITAL CONTENT”. The entire disclosure of the above patent application is hereby incorporated by reference.

### FIELD OF THE INVENTION

The present application generally relates to the field of mobile applications. Particularly, the application provides a method and system for creating a social group for mobile communication device's lock screen for sharing digital content using a mobile lock screen application.

### BACKGROUND

The mobile communication technology has completely transformed the way of human interaction. With the advent of modern technology a variety of mobile communication devices, protocols, application have populated the communication domain. Apart from the basic communication services provided by the mobile communication devices, a user may also enjoy several other services through various mobile applications, such as social networking, advertising to name a few. However, most of the application requires the mobile communication device to be unlocked before they can be used.

Every mobile communication device has a lock screen, which provides with the user ability to communicate visually on a space that can never be missed. Several applications have been designed and implemented for the mobile communication device's lock screen, wherein the users may always stay up to date on the people and brands they follow and care about most.

Prior art literature illustrates a variety of mobile applications for lock screen of mobile communication devices, such as lock screen content and advertising platforms. However, the lock screen space of the mobile communication device is still missing a social component. Thus prior art solutions fail to facilitate user defined greater interaction of user via the lock screen of the mobile communication device.

Thus, in the light of the above mentioned background art, it is evident that, there is a need for a new way for users to interact via the lock screen of the mobile communication device. There is also a need for a method and system which could facilitate creation of an open community around the lock screen space of the mobile communication device for sharing digital content by users. A method and system is desired for creating a social group for mobile lock screen for sharing digital content using a mobile lock screen application.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a method and system for creating a social group for mobile communication device's lock screen for sharing digital content using a mobile lock screen application.

In an embodiment of the present invention, a method for creating a social group for mobile communication device's lock screen for sharing digital content using a mobile lock screen application; wherein said method comprise of activating a mobile lock screen application by a user for creating a social group for mobile communication device's lock screen for sharing digital content using a mobile application; creating said social group for mobile communication device's lock screen by the user by providing information pertaining to the group such as a name for the social group, a description for the social group, an image representing the social group, selecting option for private social group or public social group; requesting for approval of said created social group for mobile communication device's lock screen sent by the user to an administrator; approving the pending request for creating social group for mobile communication device's lock screen by the administrator; joining the newly created social group for mobile communication device's lock screen by a plurality of followers and becoming a member; and inviting other to join the newly created social group for mobile communication device's lock screen by the group creator or group leaders and group members and upon joining of others, the user is enabled to share digital content by pushing digital content to other group member of said created social group via said mobile lock screen application.

The above said method and system is provided for creating a social group for mobile communication device's lock screen for sharing digital content using a mobile lock screen application but also can be used for many other medical procedures, other instructional or educational tasks.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1: shows a flow chart illustrating method for creating a social group for mobile communication device's lock screen for sharing digital content using a mobile lock screen application.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

The present application enables a method and system for creating a social group for mobile communication device's lock screen for sharing digital content using a mobile lock screen application.

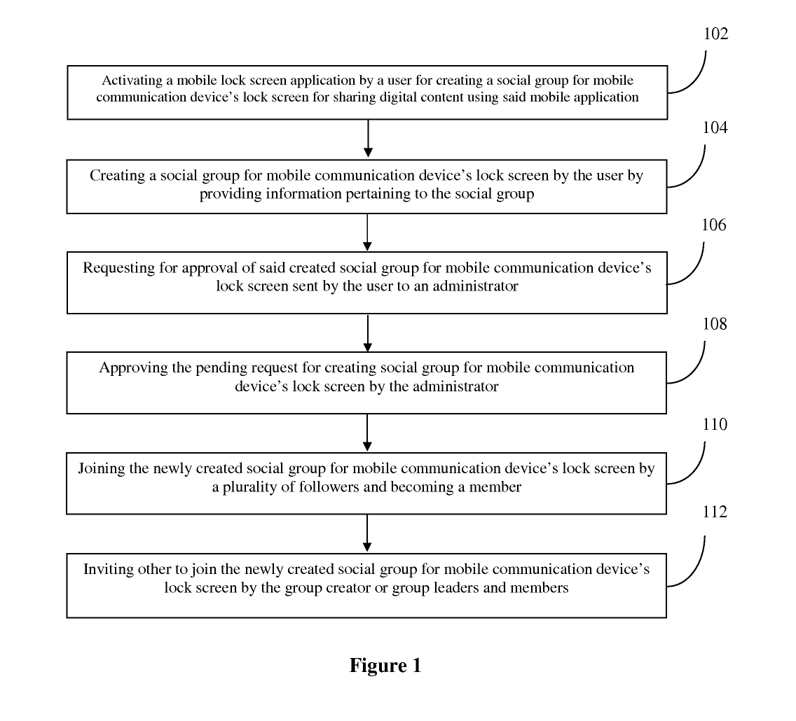

Referring to FIG. 1 is a flow chart illustrating method for creating a social group for mobile communication device's lock screen for sharing digital content using a mobile lock screen application.

The process starts at the step 102, a mobile lock screen application is activated by a user for creating a social group for mobile communication device's lock screen for sharing digital content using a mobile lock screen application.

In an embodiment of the present invention, a system is provided for creating a social group for a mobile communication device's lock screen for sharing digital content using a mobile lock screen application. The system comprises of a mobile lock screen application residing in a mobile communication device which is activated by a user for creating said social group for mobile communication device's lock screen, wherein the mobile communication device is selected from a group comprising but not limited to mobile phone, laptop, and PDA.

In another embodiment of the present invention, a method and system is provided for creating a social group or community for mobile communication device's lock screen for sharing digital content using a mobile lock screen application. Wherein such digital content could be personal or commercial lock screen content. Further, the group member may share personal and commercial lock screen content with said social group or across the entire network with other groups. The digital content is selected from a group comprising but not limited to multimedia content including text message, image, audio and video.

In another embodiment of the present invention, the mobile lock screen application displaying user defined customized digital content, wherein the user may customize the digital content according to the interest categories, groups categories, shopping categories, demographics, and psychographics. The user is enabled to send full screen messages to one another via mobile lock screen application. The user can also choose to follow the group/individual they wish to receive content on and the group owner would be able to push content (images) to his followers via the lock screen.

At the step 104, a social group for mobile communication device's lock screen is created by the user by providing information pertaining to the group such as a name for the social group, a description for the social group, an image representing the social group, selecting option for private social group or public social group. Further, the user sends a request for approval of said created social group mobile communication device's lock screen to administrator.

At the step 106, the pending request for creating social group for mobile communication device's lock screen is approved by the administrator.

At the step 108, the newly created social group for mobile communication device's lock screen is joined by a plurality of followers and they may become a member.

In an embodiment of the present invention, once the request for creating social group for mobile communication device's lock screen is approved, the user, who is group creator or group leader, may start inviting friends to join the newly created social group for mobile communication device's lock screen. The group creator or group leader may start sharing digital content by way of pushing custom lock screen messages or images to members or a plurality of followers of the group. The private social groups for mobile communication device's lock screen may be joined by invite only. Only private group for mobile communication device's lock screen members can invite each other. The private group for mobile communication device's lock screen may not be searchable on the mobile communication device's social community section.

Further the members of the newly created social group for mobile communication device's lock screen may suggest digital content to be added to the group for other followers to see, the group creator or group leader needs to approve such digital content for followers.

The process ends at the step 110, the group creator or group leaders and members may further invite others to join from within the group and upon joining of others, the user is enabled to share digital content by pushing digital content to other group member of said created social group via said mobile lock screen application.

In another embodiment of the present invention, the end user of the mobile communication device's lock screen application may choose to interact and respond to this pushed digital content by commenting inside the social group by swiping left, sharing it, or just ignoring it and using their phone as normal.

In another embodiment of the present invention, a method and system is provided for rewarding a user with redeemable reward points for viewing specific digital content. Specifically, according to the instant invention a user is rewarded for viewing specific digital content and provided with reward points which could be redeemed against mobile recharge, shopping, event tickets, movie tickets etc.

In another embodiment of the present invention, a method and system for providing an in built social shopping network for the mobile lock screen network for shopping merchandise. Similarly if the group owner is a retail brand they can push product purchase requests through lock screen to the members of the social group. Furthermore, the present invention also provided an in built social shopping network for the mobile lock screen network, wherein said shopping network may display merchandise updates, deals, and offers on the lock screen. The user is enabled to swipe left to engage in the item within the shopping network; add the selected item to cart to make a purchase, add the item to wish list, or share the item within their social group members or non-members.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

1. A method for creating a social group for a mobile communication device's lock screen for sharing digital content using a mobile lock screen application; said method comprises of:
a. activating a mobile lock screen application by a user for creating said social group for mobile communication device's lock screen;
b. creating said social group for mobile communication device's lock screen by the user by providing information pertaining to the social group;
c. requesting for approval of said created social group for mobile communication device's lock screen sent by the user to an administrator;
d. approving the pending request for creating social group for mobile communication device's lock screen by the administrator;
e. joining the newly created social group for mobile communication device's lock screen by a plurality of followers and becoming a member; and
f. inviting others to join the newly created social group for mobile communication device's lock screen by the group creator user and group members and upon joining of others, the user is enabled to share digital content by pushing digital content to other group member of said created social group via said mobile lock screen application.

2. The method as claimed in claim 1, wherein said digital content is selected from a group comprising of user's personal or commercial lock screen digital content.

3. The method as claimed in claim 1, wherein said digital content is selected from a group comprising of multimedia content including text message, image, audio and video.

4. The method as claimed in claim 1, wherein said digital content is shared with said created social group or other than the said created social group across the entire network of groups.

5. The method as claimed in claim 1, wherein the information pertaining to the social group is selected from a group comprising of a name for the social group, a description for the social group, an image representing the social group.

6. The method as claimed in claim 1, wherein the user is provided with a selection option while creating said social group for mobile communication device's lock screen for creating a private social group or a public social group.

7. The method as claimed in claim 1, further comprises of displaying user defined customized digital content, wherein the user is enabled to customize the digital content according to the interest categories, groups categories, shopping categories, demographics, and psychographics using mobile lock screen application.

8. The method as claimed in claim 1, wherein the user receiving digital content is enabled to interact and respond to said pushed digital content by commenting inside the social group by swiping left, sharing it, or just ignoring it and using their phone as normal.

9. The method as claimed in claim 1, further comprise of rewarding the user with redeemable reward points for viewing specific digital content.

10. The method as claimed in claim 1, further comprise of building a social shopping network for the mobile lock screen network for shopping merchandise, wherein the digital content receiving users are pushed with digital content containing product purchase requests through mobile lock screen.

11. (canceled)
